(19) United States
(12) Patent Application Publication
(10) Pub. No.: US 2015/0132626 A1
(43) Pub. Date: May 14, 2015

(54) ELECTRODE ASSEMBLY AND SECONDARY BATTERY USING THE ELECTRODE ASSEMBLY

(71) Applicant: Samsung SDI Co., Ltd., Yongin-si (KR)

(72) Inventors: Young-Jin Park, Yongin-si (KR); Do-Hyung Park, Yongin-si (KR); Ki-Hyun Kim, Yongin-si (KR); Min-Han Kim, Yongin-si (KR); Sang-Hoon Kim, Yongin-si (KR); Yu-Mi Song, Yongin-si (KR); Sun-Ho Kang, Yongin-si (KR); Kwang-Hwan Cho, Yongin-si (KR)

(21) Appl. No.: 14/531,734

(22) Filed: Nov. 3, 2014

(30) Foreign Application Priority Data
Nov. 11, 2013 (KR) 10-2013-0136544

(51) Int. Cl. H01M 10/0562; H01M 4/505; H01M 4/58; H01M 2/16; H01M 10/04; H01M 4/525

(52) U.S. Cl. CPC H01M 10/0562; H01M 10/0431; H01M 4/525; H01M 4/5825; H01M 2/1686; H01M 4/505; H01M 2300/0071
USPC 429/94; 429/233; 429/223; 429/221; 429/220; 429/224; 429/231.5; 429/231.95; 429/144; 429/156

(57) ABSTRACT

An electrode assembly and a secondary battery using the same are disclosed. The electrode assembly includes a positive electrode, a negative electrode, and a lithium ion conductor layer disposed at least in one of between the positive electrode and the negative electrode, on an outer surface of the positive electrode, and on an outer surface of the negative electrode, to improve thermal safety of the secondary battery.

### INCORPORATION BY REFERENCE TO ANY PRIORITY APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0136544, filed on Nov. 11, 2013, in the Korean Intellectual Property Office, the disclosure of which is incorporated herein in its entirety by reference.

### BACKGROUND

1. Field

This disclosure relates to an electrode assembly and a secondary battery including the same.

2. Description of the Related Technology

Secondary batteries are currently in wide use in the field of small, high-tech electronic devices such as digital cameras, mobile devices, and laptop computers. With the spread of electric cars including hybrid electric vehicles (HEVs), plug-in hybrid electric vehicles (PHEVs), and electric vehicles (EVs), medium- or large-sized secondary batteries with high capacity and high safety for these electric vehicles are under development.

Secondary batteries may include, for example, nickel-cadmium (Ni—Cd) batteries, nickel-metal hydride batteries, nickel-hydrogen batteries, and lithium secondary batteries. Lithium secondary batteries may be used for high-power applications by being connected in series. In addition, the lithium secondary batteries may have a higher operating voltage and a higher energy density per unit weight than nickel-cadmium batteries or nickel-metal hydride batteries, and thus are becoming more increasingly used.

However, increasing the energy density of a lithium secondary battery may deteriorate the safety of the lithium secondary battery. For example, during the charging of the lithium secondary battery, lithium dendrites may form and grow from plating of lithium ions on a negative electrode, and consequently may penetrate a separator, thus causing an internal short. This may cause heat generation, a fire, or thermal runaway in the lithium secondary battery, and a rupture of the lithium secondary battery. Therefore, there is a need to increase the energy density of a second lithium battery and at the same time ensure safety thereof.

### SUMMARY

One aspect of the disclosure relates to an electrode assembly that includes a lithium ion conductor layer to ensure the safety of a secondary battery.

Another aspect of the disclosure relates to a secondary battery including the electrode assembly.

One aspect of the disclosure relates to a secondary battery that includes a plurality of the electrode assemblies to ensure a high energy density and improved safety of the secondary battery.

Additional aspects will be set forth in part in the description which follows and, in part, will be apparent from the description, or may be learned by practice of the presented embodiments.

According to one or more embodiments of the disclosure, an electrode assembly may include, for example, a positive electrode including a positive electrode current collector and a positive active material coated on the positive electrode current collector; a negative electrode including a negative electrode current collector and a negative active material coated on the negative electrode current collector; and a lithium ion conductor layer disposed at least in one of between the positive electrode and the negative electrode, on an outer surface of the positive electrode, and on an outer surface of the negative electrode.

In some embodiments, the electrode assembly may have a wound stack of the positive electrode, the negative electrode, and the lithium ion conductor layer.

In some embodiments, the lithium ion conductor layer may be disposed at least in two of between the positive electrode and the negative electrode, on the outer surface of the positive electrode, and on the outer surface of the negative electrode.

In some embodiments, the electrode assembly may further include a separator disposed between the positive electrode and the negative electrode.

In some embodiments, the lithium ion conductor layer may be disposed at least in one of between the positive electrode and the separator, between the negative electrode and the separator, on the outer surface of the positive electrode, and on the outer surface of the negative electrode.

In some embodiments, the lithium ion conductor layer may include at least one sulfide-based lithium ion conductor selected from the group consisting of a lithium superionic conductor (LISICON), a Garnet lithium ion conductor, a Perovskite lithium ion conductor, a lithium phosphorus oxinitride (LIPON) lithium ion conductor, an sodium (Na) superionic conductor (NASICON), and a combination thereof.

In some embodiments, the positive active material may include at least one of a lithium-nickel composite oxide represented by Formula 1, an olivine-based phosphoric acid compound represented by Formula 2, a spinel-based lithium-manganese composite oxide represented by Formula 3, and a combination thereof:

Liₐ(NiₓM′_{y})O₂ Formula 1

wherein, in Formula 1, M′ may be at least one element selected from the group consisting of cobalt (Co), manganese (Mn), iron (Fe), vanadium (V), copper (Cu), chromium (Cr), aluminum (Al), magnesium (Mg), and titanium (Ti), 0.9<a≦1.1, 0≦x<0.6, 0.4≦y≦1, and x+y=1, wherein M′ may be optionally substituted or doped with at least one heterogeneous element selected from the group consisting of calcium (Ca), magnesium (Mg), aluminum (Al), titanium (Ti), strontium (Sr), iron (Fe), cobalt (Co), nickel (Ni), copper (Cu), zinc (Zn), yttrium (Y), zirconium (Zr), niobium (Nb), and boron (B);

LiMPO₄ Formula 2

wherein, in Formula 2, M may be at least one element selected from the group consisting of Fe, Mn, Ni, Co, and V; and

Li_{1+y}Mn_{2-y-z}M_{z}O₄₋ₓQₓ Formula 3

wherein, in Formula 3, M may be at least one element selected from the group consisting of Mg, Al, Ni, Co, Fe, Cr, Cu, boron (B), Ca, Nb, Mo, Sr, antimony (Sb), tungsten (W), Ti, V, Zr, and Zn, and Q may be at least one element selected from the group consisting of nitrogen (N), fluorine (F), sulfur (S), and chlorine (Cl), 0≦x≦1, 0≦y≦0.34, and 0≦z≦1.

In some embodiments, the lithium ion conductor layer may have a thickness of about 5 nm to about 500 μm.

In some embodiments, the separator may be coated with an inorganic material or an organic material.

According to one or more embodiments of the disclosure, a secondary battery includes any of the electrode assemblies described herein.

According to one or more embodiments of the disclosure, a secondary battery may include: a case; a first electrode assembly and a second electrode assembly placed in and adjacent to inner walls of the case; and a third electrode assembly disposed between the first electrode assembly and the second electrode assembly in the case, wherein an energy density of the third electrode assembly may be higher than energy densities of the first electrode assembly and the second electrode assembly.

In some embodiments, the first electrode assembly may include a first positive electrode including a first positive electrode current collector and a positive active material coated on the first positive electrode current collector; a first negative electrode including a first negative electrode current collector and a first negative active material coated on the first negative electrode current collector; and a first lithium ion conductor layer disposed at least in one of between the first positive electrode and the first negative electrode, on an outer surface of the first positive electrode, and an outer surface of the first negative electrode; the second electrode assembly may include a second positive electrode including a second positive electrode current collector and a second positive active material coated on the second positive electrode current collector; a second negative electrode including a second negative electrode current collector and a second negative active material coated on the second negative electrode current collector; and a second lithium ion conductor layer disposed at least in one of between the second positive electrode and the second negative electrode, on an outer surface of the second positive electrode, and an outer surface of the second negative electrode; the first lithium ion conductor layer and the second lithium ion conductor layer may be the same or different; and the third electrode assembly may include a third positive electrode including a third positive electrode current collector and a third positive active material coated on the positive electrode current collector; a third negative electrode including a third negative electrode current collector and a third negative active material coated on the third negative electrode current collector; and a third separator disposed between the third positive electrode and the third negative electrode.

In some embodiments, the first electrode assembly may have a wound stack of the first positive electrode, the first negative electrode, and the first lithium ion conductor layer; the second electrode assembly may have a wound stack of the second positive electrode, the second negative electrode, and the second lithium ion conductor layer; and the third electrode assembly may have a wound stack of the third positive electrode, the third separator, and the third negative electrode.

In some embodiments, the first electrode assembly may further include a first separator disposed between the first positive electrode and the first negative electrode, and the second electrode assembly may further include a second separator disposed between the second positive electrode and the second negative electrode.

In some embodiments, the first lithium ion conductor layer may be disposed at least in one of between the first positive electrode and the first separator, between the first negative electrode and the first separator, on the outer surface of the first positive electrode, and on the outer surface of the first negative electrode, and the second lithium ion conductor layer may be disposed at least in one of between the second positive electrode and the second separator, between the second negative electrode and the second separator, on the outer surface of the second positive electrode, and on the outer surface of the second negative electrode.

In some embodiments, the first lithium ion conductor layer and the second lithium ion conductor layer may each include at least one sulfide-based lithium ion conductor selected from the group consisting of a lithium superionic conductor (LISICON), a Garnet lithium ion conductor, a Perovskite lithium ion conductor, a lithium phosphorus oxinitride (LIPON) lithium ion conductor, an Na superionic conductor (NASICON), and a combination thereof, and the first lithium ion conductor layer and the second lithium ion conductor layer may each have a thickness of about 5 nm to about 500 μm

In some embodiments, the first positive active material and the second positive active material may each independently include at least one of a lithium-nickel composite oxide represented by Formula 1, an olivine-based phosphoric acid compound represented by Formula 2, a spinel-based lithium manganese composite oxide represented by Formula 3, and a combination thereof:

Liₐ(NiₓM′_{y})O₂ Formula 1

wherein, in Formula 1, M′ may be at least one element selected from the group consisting of cobalt (Co), manganese (Mn), iron (Fe), vanadium (V), copper (Cu), chromium (Cr), aluminum (Al), magnesium (Mg), and titanium (Ti), 0.9<a≦1.1, 0≦x<0.6, 0.4≦y≦1, and x+y=1, wherein M′ may be optionally substituted or doped with at least one heterogeneous element selected from calcium (Ca), magnesium (Mg), aluminum (Al), titanium (Ti), strontium (Sr), iron (Fe), cobalt (Co), nickel (Ni), copper (Cu), zinc (Zn), yttrium (Y), zirconium (Zr), niobium (Nb), and boron (B);

LiMPO₄ Formula 2

wherein, in Formula 2, M may be at least one element selected from the group consisting of Fe, Mn, Ni, Co, and V; and

Li_{1+y}Mn_{2-y-z}M_{z}O₄₋ₓQₓ Formula 3

wherein, in Formula 3, M may be at least one element selected from the group consisting of Mg, Al, Ni, Co, Fe, Cr, Cu, boron (B), Ca, Nb, Mo, Sr, antimony (Sb), tungsten (W), boron (B), Ti, V, Zr, and Zn, and Q may be at least one element selected from the group consisting of nitrogen (N), fluorine (F), sulfur (S), and Cl, 0≦x≦1, 0≦y≦0.34, and 0≦z≦1.

In some embodiments, the third positive active material may include a lithium-nickel composite oxide represented by Formula 4:

Liₐ(NiₓM′_{y}M″_{z})O₂

wherein, in Formula 4, M′ may be at least one element selected from the group consisting of Co, Mn, Ni, Al, Mg, and Ti, M″ may be at least one element selected from the group consisting of Ca, Mg, Al, Ti, Sr, Fe, Co, Ni, Cu, Zn, Y, Zr, Nb, boron (B), and a combination thereof, 0.4<a≦1.3, 0.6≦x≦1, 0≦y≦0.4, 0≦z≦0.4, and x+y+z=1.

In some embodiments, a thickness of the first positive electrode current collector and a thickness of the second positive electrode current collector may be the same or different and may be each independently 1 to about 2 times greater than a thickness of the third positive electrode current collector, and a thickness of the first negative electrode current collector and a thickness of the second negative electrode current collector may be the same or different and may be each independently 1 to about 2 times greater than a thickness of the third negative electrode current collector.

In some embodiments, a thickness of the first separator and a thickness of the second separator may be the same or different, and may be 1 to about 2 times greater than a thickness of the third separator, and the first separator or the second separator may be coated with an inorganic material or an organic material.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic perspective view of a general jelly-roll type electrode assembly;

FIG. 2 is a schematic cross-sectional view of an electrode assembly according to an embodiment;

FIGS. 3A and 3B are schematic cross-sectional views of electrode assemblies according to certain embodiments;

FIGS. 4A to 4F are schematic cross-sectional views of electrode assemblies according to certain embodiments;

FIG. 5 is a schematic cross-sectional view of a secondary battery according to an embodiment; and

FIG. 6 is a schematic cross-sectional view of a secondary battery according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. In the description of the present embodiments, certain detailed explanations of related art are omitted when it is deemed that they may unnecessarily obscure the essence of the embodiments. While such terms as “first,” “second,” etc., may be used to describe various components, such components must not be limited to the above terms. The above terms are used only to distinguish one component from another. The terms used in the present specification are merely used to describe particular embodiments, and are not intended to limit the present embodiments. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. As used herein, “I” may be construed, depending on the context, as referring to “and” or “or”. As used herein, the term “and/or” includes any and all combinations of one or more of the associated listed items. Expressions such as “at least one of,” when preceding a list of elements, modify the entire list of elements and do not modify the individual elements of the list.

In the drawings, the thicknesses of layers and regions are exaggerated for clarity. Like reference numerals in the drawings and specification denote like elements It will be understood that when an element, for example, a layer, a film, a region, or a substrate, is referred to as being “on” or “above” another element, it can be directly on the other element or intervening layers may also be present.

In general, electrode assemblies may be classified into either a jelly-roll type in which a stack of a positive electrode and an negative electrode with a separator disposed between the positive electrode and the negative electrode is wound, or a stack type as a stack of a plurality of positive electrodes, a plurality of separators, and a plurality of negative electrodes that are alternately stacked upon one another in the stated order. Such jelly-roll type electrode assemblies have a simple structure easy to manufacture, and a high energy density per weight, compared to stack type electrode assemblies.

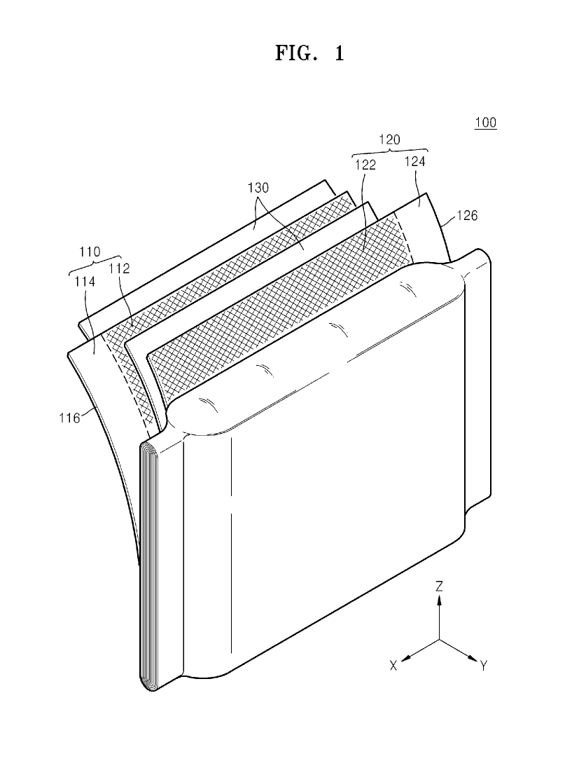

FIG. 1 is a schematic perspective view of a general jelly-roll type electrode assembly 100.

The jelly-roll type electrode assembly 100 may be manufactured by winding a stack of a positive electrode 110 and a negative electrode 120 that are coated with positive and negative active materials, respectively, a separator 130 disposed between the positive electrode 110 and the negative electrode 120, with another separator 130 disposed on an outer surface of the positive electrode 110 (or the negative electrode 120), to have a circular cross-sectional structure.

The positive electrode 110 may have a coated region 112 of a positive active material on a positive electrode current collector 116, and a non-coated region 114 in which no positive active material is coated. The negative electrode 120 may have a coated region 122 of the negative active material on a negative electrode current collector 126, and a non-coated region 124 in which no negative active material is coated.

The separator 130 may include a polymer membrane with a porous structure and may allow transfer of ions between the positive electrode 110 and the negative electrode 120 through the porous structure during charging and discharging, and may prevent an abnormal current flow, an abrupt internal pressure and temperature rise, and a fire that are caused by a short circuit. The jelly-roll type electrode assembly may further include an additional separator 130 on the outer surface of the positive electrode 110 as illustrated in FIG. 1, or an outer surface of the negative electrode 120, to prevent a short circuit.

However, the separator 130 is vulnerable to damage caused from an internal or external impact due to poor mechanical properties. Such damage in the separator 130 may cause an internal short in a battery, and deteriorate performance thereof.

According to an embodiment of the present disclosure, an electrode assembly includes: a positive electrode including a positive electrode current collector and a positive active material coated on the positive electrode current collector; a negative electrode including a negative electrode current collector and a negative active material coated on the negative electrode current collector; and a lithium ion conductor layer disposed at least in one of between the positive electrode and the negative electrode, on an outer surface of the positive electrode, and on an outer surface of the negative electrode. In some embodiments, the electrode assembly may have a wound stack of the positive electrode, the negative electrode, and the lithium ion conductor layer.

In the electrode assembly, the lithium ion conductor layer may transfer, like a separator, lithium ions from the positive electrode to the negative electrode during charging or from the negative electrode to the positive electrode during discharging. When the lithium ion conductor layer is disposed between the positive electrode and the negative electrode, the lithium ion conductor layer may prevent, like a separator, contact between the positive and negative electrodes and migration of materials separated from the positive or negative electrode into the other electrode. Accordingly, a separator may not be disposed between the positive electrode and the negative electrode when the lithium ion conductor layer is disposed between the positive electrode and the negative electrode. Furthermore, the lithium ion conductor layer has relatively high lithium ion conductivity, and thus may constitute an electrolyte assembly without additional liquid electrolyte when the lithium ion conductor layer is disposed between the positive electrode and the negative electrode. When the lithium ion conductor layer is used in the electrode assembly, lithium dendrites may be less likely grown on the negative electrode to contact the positive electrode during repeated charge and discharge cycles, so that an internal short causing a consequential thermal runaway may be prevented even when the separator is penetrated by the dendrites, and the safety of the battery may be improved.

Other embodiments of the electrode assembly according to the present disclosure will be described with reference to FIGS. 2 to 4F.

FIG. 2 is a schematic cross-sectional view of an electrode assembly according to an embodiment.

Referring to FIG. 2, the electrode assembly may include a positive electrode 210 including a positive electrode current collector and a positive active material coated on the positive electrode current collector (not shown), a negative electrode 220 including a negative electrode current collector and a negative active material coated on the negative electrode current collector (not shown), and a lithium ion conductor layer 240 disposed between the positive electrode 210 and the negative electrode 220. The electrode assembly may further include a separator 230 on an outer surface of the positive electrode 210 or an outer surface of the negative electrode 220 to prevent an internal short. A stack of the positive electrode 210, the lithium ion conductor layer 240, the negative electrode 220, and the separator 230 that are sequentially stacked upon one another as illustrated in FIG. 2 may be wound to form a jelly-roll type electrode assembly. A positive electrode tab 218 extending from the non-coated region of the positive electrode may be directly connected to a battery case (not shown), while a negative electrode tab 228 extending from the non-coated region of the negative electrode may protrude to contact a pin (not shown), so that a structure of electrical connection to the outside may be achieved.

In some embodiments, the electrode assembly may include lithium ion conductor layers 240 that may be disposed at least in two of between the positive electrode and the negative electrode, on the outer surface of the positive electrode, and on the outer surface of the negative electrode. This electrode assembly may prevent a short circuit caused by an internal or external factor of a battery, and further improve safety of the battery.

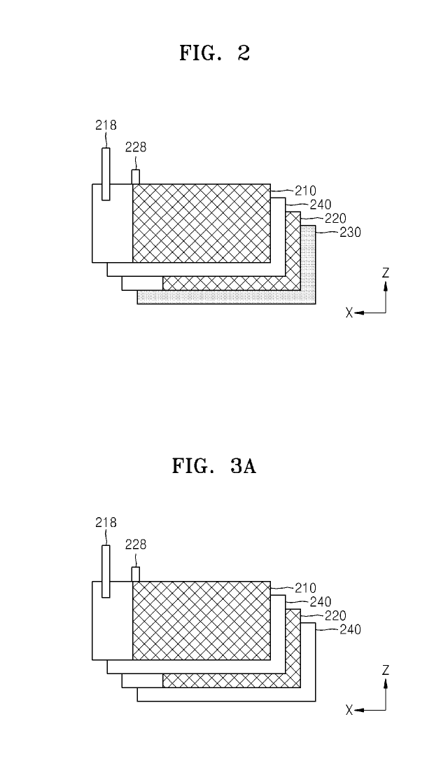

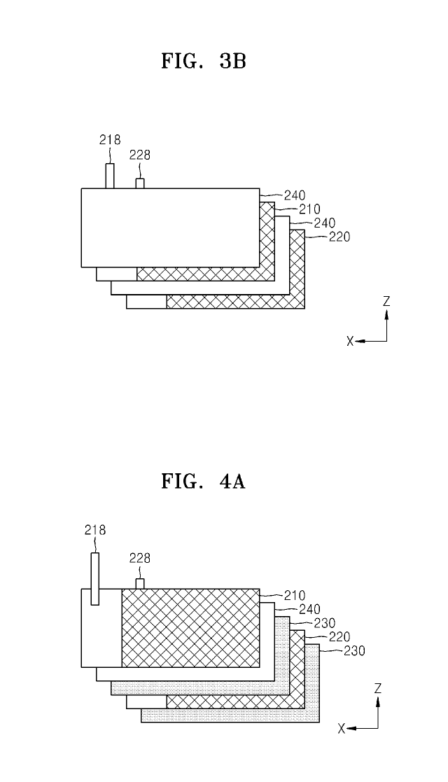

FIGS. 3A and 3B are schematic cross-sectional views of electrode assemblies according to embodiments.

Referring to FIG. 3A, an electrode assembly according to an embodiment may include a positive electrode 210 including a positive electrode current collector and a positive active material coated on the positive electrode current collector (not shown), a negative electrode 220 including a negative electrode current collector and a negative active material coated on the negative electrode current collector (not shown), and two lithium ion conductor layers 240 disposed between the positive electrode 210 and the negative electrode 220 and on an outer surface of the negative electrode 220, respectively. In some embodiments, a stack of the positive electrode 210, the lithium ion conductor layer 240, the negative electrode 220, and the lithium ion conductor layer 240 that are sequentially stacked upon one another as illustrated in FIG. 3A may be wound to form a jelly-roll type electrode assembly. A positive electrode tab 218 extending from the non-coated region of the positive electrode may be directly connected to a battery case (not shown), while a negative electrode tab 228 extending from the non-coated region of the negative electrode may protrude to contact a pin (not shown), so that a structure of electrical connection to the outside may be achieved.

Referring to 3B, an electrode assembly according to another embodiment may include a positive electrode 210 including a positive electrode current collector and a positive active material coated on the positive electrode current collector (not shown), a negative electrode 220 including a negative electrode current collector and a negative active material coated on the negative electrode current collector (not shown), and two lithium ion conductor layers 240 that are disposed between the positive electrode 210 and the negative electrode 220 and on an outer surface of the positive electrode 210, respectively. In some embodiments, a stack of the lithium ion conductor layer 240, the positive electrode 210, the lithium ion conductor layer 240, and the negative electrode 220 that are sequentially stacked upon one another as illustrated in FIG. 3B may be wound to form a jelly-roll type electrode assembly. A positive electrode tab 218 extending from the non-coated region of the positive electrode may be directly connected to a battery case (not shown), while a negative electrode tab 228 extending from the non-coated region of the negative electrode may protrude to contact a pin (not shown), so that a structure of electrical connection to the outside may be achieved.

In some embodiments, an electrode assembly according to another embodiment may include a positive electrode formed by coating a positive active material on a positive current collector, a negative electrode formed by coating a negative active material on a negative current collector, and three lithium ion conductor layers disposed between the positive electrode and the negative electrode, on an outer surface of the positive electrode, and on an outer surface of the negative electrode, respectively. A stack of the lithium ion conductor layer, the positive electrode, the lithium ion conductor layer, the negative electrode, and the lithium ion conductor layer that are sequentially stacked upon one another may be wound to form a jelly-roll type electrode assembly.

Any of the electrode assemblies according to the above-described embodiments may further include a separator disposed between the positive electrode and the negative electrode.

When the electrode assembly further includes a separator between the positive electrode and the negative electrode, lithium ion conductor layer may be disposed at least in one of between the positive electrode and the separator, between the negative electrode and the separator, on an outer surface of the positive electrode, and on an outer surface of the negative electrode. When the at least one lithium ion conductor layer is disposed between the positive electrode and the separator and/or between the negative electrode and the separator, a damage of the separator and an internal short of the electrode that is caused by an internal or external factor of a battery may less likely occur, so that safety of the battery may be improved. When the lithium ion conductor layer is disposed between the negative electrode and the separator, the lithium ion conductor layer may protect the negative electrode. Accordingly, lithium dendrites may be less likely grown on the negative electrode to contact the positive electrode during repeated charge and discharge cycles, so that the separator may not be penetrated by the dendrites capable of causing an internal short, and the safety of the battery may be improved.

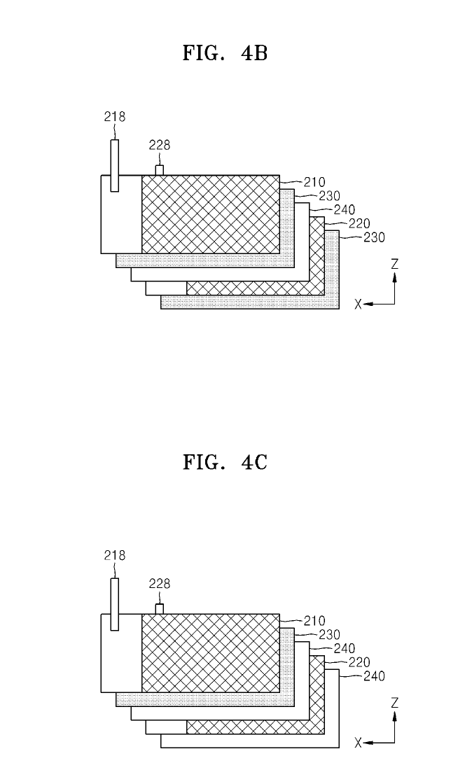

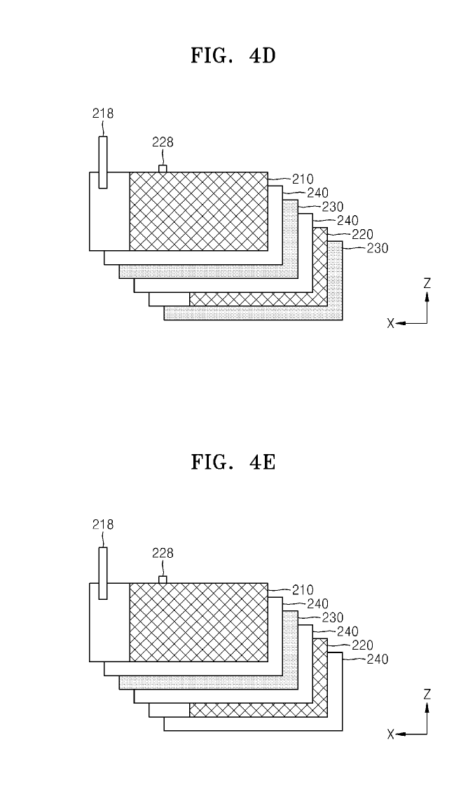

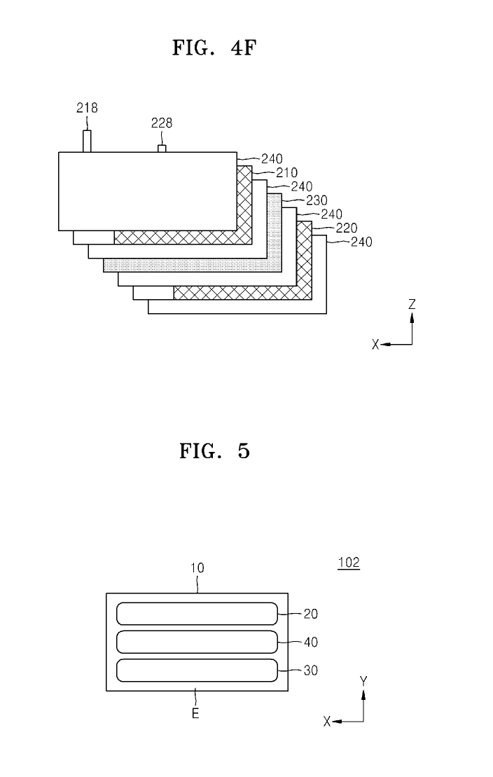

FIGS. 4A to 4F are schematic cross-sectional views of electrode assemblies according to other embodiments of the present disclosure.

Referring to FIG. 4A, an electrode assembly according to an embodiment may include a positive electrode 210 including a positive electrode current collector and a positive active material coated on the positive electrode current collector (not shown), a negative electrode 220 including a negative electrode current collector and a negative active material coated on the negative electrode current collector (not shown), a separator 230 disposed between the positive electrode 210 and the negative electrode 220, and a lithium ion conductor layer 240 disposed between the positive electrode 210 and the separator 230. In some embodiments, the electrode assembly may further include another separator 230 on an outer surface of the positive electrode 210 or an outer surface of the negative electrode 220 to prevent an internal short. In some embodiments, a stack of the positive electrode 210, lithium ion conductor layer 240, the separator 230, the negative electrode 220, and the other separator 230 that are sequentially stacked upon one another as illustrated in FIG. 4A may be wound to form a jelly-roll type electrode assembly. A positive electrode tab 218 extending from the non-coated region of the positive electrode may be directly connected to a battery case (not shown), while a negative electrode tab 228 extending from the non-coated region of the negative electrode may protrude to contact a pin (not shown), so that a structure of electrical connection to the outside may be achieved.

Referring to FIG. 4B, an electrode assembly according to another embodiment may include a positive electrode 210 including a positive electrode current collector and a positive active material coated on the positive electrode current collector (not shown), a negative electrode 220 including a negative electrode current collector and a negative active material coated on the negative electrode current collector (not shown), a separator 230 disposed between the positive electrode 210 and the negative electrode 220, and a lithium ion conductor layer 240 disposed between the negative electrode 220 and the separator 230. In some embodiments, the electrode assembly may further include another separator 230 on an outer surface of the positive electrode 210 or an outer surface of the negative electrode 220 to prevent an internal short. In some embodiments, a stack of the positive electrode 210, the separator 230, the lithium ion conductor layer 240, the negative electrode 220, and the other separator 230 that are sequentially stacked upon one another as illustrated in FIG. 4B may be wound to form a jelly-roll type electrode assembly. A positive electrode tab 218 extending from the non-coated region of the positive electrode may be directly connected to a battery case (not shown), while a negative electrode tab 228 extending from the non-coated region of the negative electrode may protrude to contact a pin (not shown), so that a structure of electrical connection to the outside may be achieved.

In some embodiments, an electrode assembly may include lithium ion conductor layers that may be disposed at least in two of between a positive electrode and a separator, between a negative electrode and a separator, on an outer surface of the positive electrode, and on an outer surface of the negative electrode.

Referring to FIG. 4C, an electrode assembly according to still another embodiment may include a positive electrode 210 including a positive electrode current collector and a positive active material coated on the positive electrode current collector (not shown), a negative electrode 220 including a negative electrode current collector and a negative active material coated on the negative electrode current collector (not shown), a separator 230 disposed between the positive electrode 210 and the negative electrode 220, and two lithium ion conductor layers 240 that are disposed between the negative electrode 210 and the separator 230 and on an outer surface of the negative electrode 220, respectively. In some embodiments, a stack of the positive electrode 210, the separator 230, the lithium ion conductor layer 240, the negative electrode 220, and the lithium ion conductor layer 240 that are sequentially stacked upon one another as illustrated in FIG. 4C may be wound to form a jelly-roll type electrode assembly. A positive electrode tab 218 extending from the non-coated region of the positive electrode may be directly connected to a battery case (not shown), while a negative electrode tab 228 extending from the non-coated region of the negative electrode may protrude to contact a pin (not shown), so that a structure of electrical connection to the outside may be achieved.

Referring to FIG. 4D, an electrode assembly according to yet another embodiment may include a positive electrode 210 including a positive electrode current collector and a positive active material coated on the positive electrode current collector (not shown), a negative electrode 220 including a negative electrode current collector and a negative active material coated on the negative electrode current collector (not shown), a separator 230 disposed between the positive electrode 210 and the negative electrode 220, and two lithium ion conductor layers 240 that are disposed between the positive electrode 210 and the separator 230 and between the negative electrode 220 and the separator 230, respectively. In some embodiments, the electrode assembly may further include another separator 230 on an outer surface of the positive electrode 210 or an outer surface of the negative electrode 220 to prevent an internal short. In some embodiments, a stack of the positive electrode 210, the lithium ion conductor layer 240, the separator 230, the lithium ion conductor layer 240, the negative electrode 220, and the other separator 230 that are sequentially stacked upon one another as illustrated in FIG. 4d may be wound to form a jelly-roll type electrode assembly. A positive electrode tab 218 extending from the non-coated region of the positive electrode may be directly connected to a battery case (not shown), while a negative electrode tab 228 extending from the non-coated region of the negative electrode may protrude to contact a pin (not shown), so that a structure of electrical connection to the outside may be achieved.

Referring to FIG. 4E, an electrode assembly according to yet still another embodiment may include a positive electrode 210 including a positive electrode current collector and a positive active material coated on the positive electrode current collector (not shown), a negative electrode 220 including a negative electrode current collector and a negative active material coated on the negative electrode current collector (not shown), a separator 230 disposed between the positive electrode 210 and the negative electrode 220, and three lithium ion conductor layers 240 that are disposed between the positive electrode 210 and the separator 230, between the negative electrode 220 and the separator 230, and on an outer surface of the negative electrode 220, respectively. In some embodiments, a stack of the positive electrode 210, the lithium ion conductor layer 240, the separator 230, the lithium ion conductor layer 240, the negative electrode 220, and the lithium ion conductor layer 240 that are sequentially stacked upon one another as illustrated in FIG. 4E may be wound to form a jelly-roll type electrode assembly. In some embodiments, the electrode assembly may further include another separator 230 on an outer surface of the positive electrode 210 or the outer surface of the negative electrode 220. A positive electrode tab 218 extending from the non-coated region of the positive electrode may be directly connected to a battery case (not shown), while a negative electrode tab 228 extending from the non-coated region of the negative electrode may protrude to contact a pin (not shown), so that a structure of electrical connection to the outside may be achieved.

Referring to FIG. 4F, an electrode assembly according to yet still another embodiment may include a positive electrode 210 including a positive electrode current collector and a positive active material coated on the positive electrode current collector (not shown), a negative electrode 220 including a negative electrode current collector and a negative active material coated on the negative electrode current collector (not shown), a separator 230 disposed between the positive electrode 210 and the negative electrode 220, and four lithium ion conductor layers 240 that are disposed between the positive electrode 210 and the separator 230, between the negative electrode 220 and the separator 230, on an outer surface of the positive electrode 210, and on an outer surface of the negative electrode 220, respectively. In some embodiments, a stack of the lithium ion conductor layer 240, the positive electrode 210, the lithium ion conductor layer 240, the separator 230, the lithium ion conductor layer 240, the negative electrode 220, and the lithium ion conductor layer 240 that are sequentially stacked upon one another as illustrated in FIG. 4F may be wound to form a jelly-roll type electrode assembly. In some embodiments, the electrode assembly may further include another separator 230 on the outer surface of the positive electrode 210 or the outer surface of the negative electrode 220. A positive electrode tab 218 extending from the non-coated region of the positive electrode may be directly connected to a battery case (not shown), while a negative electrode tab 228 extending from the non-coated region of the negative electrode may protrude to contact a pin (not shown), so that a structure of electrical connection to the outside may be achieved.

Each of the lithium ion conductor layers according to the above-described embodiments may include a ceramic-based lithium ion conductor or a polymer-based lithium ion conductor. In some embodiments, the lithium ion conductor layer may include a sulfide-based lithium ion conductor as a ceramic-based lithium ion conductor. For example, the lithium ion conductor layer may include at least one sulfide-based lithium ion conductor selected from the group consisting of a lithium superionic conductor (LISICON), a Garnet lithium ion conductor, a Perovskite lithium ion conductor, a lithium phosphorus oxinitride (LIPON) lithium ion conductor, a sodium (Na) superionic conductor (NASICON), and a combination thereof. For example, the lithium ion conductor layer may include a LISICON.

Non-limiting examples of the LISICON are Li₂S—P₂S₅, Li₂S—SiS₂, Li₂S—SiS₂—P₂S₅, Li₂S—GeS₂, Li₂O—Al₂O₃—SiO₂—P₂O₅—TiO₂, Li₂O—Al₂O₃—SiO₂—P₂O₅—TiO₂—GeO₂, and Li₃PO₄—Li₂S—SiS₂. For example, Li₂O—Al₂O₃—SiO₂—P₂O₅—TiO₂—GeO₂ may be used as the LISICON.

In some embodiments, the lithium ion conductor layer may be a film including a lithium ion conductor. In some other embodiments, the lithium ion conductor layer may be formed by coating a lithium ion conductor on the positive electrode or the negative electrode. In some embodiments, the coating may be performed by coating and drying via sol-gel treatment, sputtering, spin coating, chemical vapor deposition (CVD), or pulse laser deposition (PLD).

In some embodiments, each of the lithium ion conductor layers may have a thickness of about 5 nm to about 500 μm When the thickness of the lithium ion conductor layer is within this range, the lithium ion conductor layer may have a mechanical strength strong enough to prevent penetration of the separator by lithium dendrites not to cause a short, and may ensure a space for the other elements of the electrode assembly to achieve a satisfactory capacity of a battery per unit volume. For example, each of the lithium ion conductor layers may have a thickness of about 1 μm to about 50 μm, and in some embodiments, a thickness of about 10 μm to about 30 μm

In some embodiments, when any of the electrode assemblies according to the above-described embodiments include a plurality of lithium ion conductor layers, materials and thicknesses of these lithium ion conductor layers may be the same or different.

In any of the electrode assemblies according to the above-described embodiments, the positive active material may include at least one of a lithium-nickel composite oxide represented by Formula 1 below, an olivine-based phosphoric acid compound represented by Formula 2 below, a spinel-based lithium-manganese composite oxide represented by Formula 3 below, and a combination thereof:

Liₐ(NiₓM′_{y})O₂ Formula 1

In Formula 1, M′ may be at least one element selected from the group consisting of cobalt (Co), manganese (Mn), iron (Fe), vanadium (V), copper (Cu), chromium (Cr), aluminum (Al), magnesium (Mg), and titanium (Ti); 0.9<a≦1.1; 0≦x≦0.6; 0.4≦y≦1; and x+y=1, wherein M′ may be optionally substituted or doped with at least one heterogeneous element selected from the group consisting of calcium (Ca), magnesium (Mg), aluminum (Al), titanium (Ti), strontium (Sr), iron (Fe), cobalt (Co), nickel (Ni), copper (Cu), zinc (Zn), yttrium (Y), zirconium (Zr), niobium (Nb), and boron (B).

LiMPO₄ Formula 2

In Formula 2, M may be at least one element selected from the group consisting of Fe, Mn, Ni, Co, and V.

Li_{1+y}Mn_{2-y-z}M_{z}O₄₋ₓQₓ Formula 3

In Formula 3, M may be at least one element selected from the group consisting of Mg, Al, Ni, Co, Fe, Cr, Cu, boron (B), Ca, Nb, Mo, Sr, antimony (Sb), tungsten (W), Ti, V, Zr, and Zn; Q may be at least one element selected from the group consisting of nitrogen (N), fluorine (F), sulfur (S), and chlorine (Cl); 0≦x≦1; 0≦y≦0.34; and 0≦z≦1.

When an amount of Ni in the lithium-nickel composite oxide is within the above range, the positive active material of the electrode assembly may have good thermal stability compared to outside the above range. In some embodiments, the olivine-based phosphoric acid compound may have a very stable crystalline structure of an olivine structure with covalently bound phosphorous and oxygen, and thus may not release oxygen even in high-temperature conditions and have high chemical safety. In some embodiments, the spinel-based lithium-manganese composite oxide may have a spinel structure of a cubic system, and thus may have good thermal safety. When the positive active material includes these materials, a battery including the positive active material may have improved safety.

In some embodiments, the lithium-nickel composite oxide may include LiNi_{1/3}Co_{1/3}Mn_{1/3}O₂. In some embodiments, the olivine-based phosphoric acid compound may include LiFePO₄. In some embodiments, the spinel-based lithium-manganese composite oxide may include LiMn₂O₄.

In any of the electrode assemblies according to the above-described embodiments, the anode active material may be a compound that allows intercalation/deintercalation of lithium. Any material available as an anode active material in the art may be used. Non-limiting examples of the anode active material are a lithium metal, a lithium alloy, a metal alloyable with lithium or an oxide of the metal, a transition metal oxide, a carbon-based material, or a mixture thereof.

Examples of the metal alloyable with lithium or the oxide of the metal are silicon (Si), SiOₓ (where 0<x<2), an Si—Y alloy (where Y is an alkali metal, an alkali earth metal, a Group XIII element, a Group XIV element, a transition metal, a rare earth element, or combinations thereof (except for Si), Sn, SnO₂, an Sn—Y alloy (where Y is an alkali metal, an alkali earth metal, a Group 13 element, a Group 14 element, a transition metal, a rare earth element, or a combination thereof (except for Sn), and combinations of at least one of these materials with SiO₂. In some embodiments, Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or combinations thereof.

Non-limiting examples of the transition metal oxide are a vanadium oxide, and a lithium titanium oxide.

Non-limiting examples of the carbon-based material are crystalline carbon, amorphous carbon, and mixtures thereof. Non-limiting examples of the crystalline carbon are graphite, such as natural graphite that is in amorphous, plate, flake, spherical or fibrous form or artificial graphite. Examples of the amorphous carbon include soft carbon (carbon sintered at low temperatures), hard carbon, meso-phase pitch carbides, sintered corks, and the like.

In any of the electrode assemblies according to the above-described embodiments, the positive or negative electrode current collector is not particularly limited, and may be any material that has conductivity and does not cause chemical changes in a battery. Non-limiting examples of the positive or negative electrode current collector are copper, stainless steel, aluminum, nickel, titanium, sintered carbon, copper or stainless steel that is surface-treated with carbon, nickel, titanium, or silver, and aluminum-cadmium alloys. In addition, the positive or negative electrode current collector may have fine irregularities on surfaces thereof so as to enhance adhesive strength of the current collector to the positive or negative active material, and may be used in any of various forms including films, sheets, foils, nets, porous structures, foams, and non-woven fabrics.

In some embodiments, the positive or negative electrode current collectors may each have a thickness of about 3 μm to about 500 μm. When the thicknesses of the positive or negative electrode current collectors are within this range, the positive or negative current collectors may have a sufficient mechanical strength and may effectively dissipate heat and disperse a current when an internal short occurs. In some embodiments, the positive electrode current collector may have a thickness of about 10 μm to about 30 μm, and the negative electrode current collector may have a thickness of about 6 μm to about 30 μm

In any of the electrode assemblies according to the above-described embodiments, the positive electrode may be formed by coating a positive active material on a positive electrode current collector. In some embodiments, the positive electrode may be manufactured by coating a positive electrode slurry composition including the positive active material, a conducting agent, a binder, and a solvent on a positive electrode current collector. In some embodiments, the positive electrode slurry composition may be cast on a separate support to form a positive active material film. In some embodiments, the positive active material film separated from the support may be laminated on the positive electrode current collector to manufacture the positive electrode with a positive electrode mixture layer. In some embodiments, the positive electrode may be any of a variety of forms, not limited to the above-described forms. Types and amounts of the conducting agent, the binder, and the solvent may be those commonly used in secondary batteries in the art.

In any of the electrode assemblies according to the above-described embodiments, the negative electrode may be formed by coating a negative active material on a negative current collector. In some embodiments, the negative electrode may be manufactured by coating a negative electrode slurry composition including the negative active material, a conducting agent, a binder, and a solvent on the negative current collector. In some embodiments, the negative electrode slurry composition may be cast on a separate support to form a negative active material film. In some embodiments, the negative active material film separated from the support may be laminated on the negative electrode current collector to manufacture the negative electrode with a negative electrode mixture layer. In some embodiments, the negative electrode may be any of a variety of forms, not limited to the above-described forms. Types and amounts of the conducting agent, the binder, and the solvent may be those commonly used in secondary batteries in the art.

In any of the electrode assemblies according to the above-described embodiments, the separator disposed between the positive electrode and the negative electrode may be any separators used in common in lithium secondary batteries. For example, a separator having low resistance to migration of ions in an electrolyte and having good electrolyte-retaining ability may be used. Non-limiting examples of the separator are glass fiber, polyester, polyethylene, polypropylene, polytetrafluoroethylene (PTFE), and a combination thereof, each of which may be a nonwoven fabric or a woven fabric. The separator may have a pore diameter of about 0.01 μm to about 10 μm

In some embodiments, the separator may have a thickness of about 5 μm to about 300 μm When the thickness of the separator is within this range, a reduction in capacity per unit volume of a battery may be suppressed, with ensured safety against an internal short. For example, the separator may have a thickness of about 8 μm to about 30 μm

In some embodiments, the separator may be coated with an inorganic or organic material to prevent spreading of a short circuit area and to improve heat absorption characteristics thereof. In some embodiments, the inorganic material may be at least one selected from the group consisting of BaTiO₃, SnO₂, CeO₂, MgO, NiO, CaO, ZnO, ZrO₂, Y₂O₃, Al₂O₃, TiO₂, SiC, and combinations thereof. In some embodiments, the organic material may be at least one selected from the group consisting of polyvinylidene fluoride-hexafluoropropylene, polyvinylidene fluoride-trichloroethylene, polymethyl methacrylate (PMMA), polyacrylonitrile, polyvinylpyrolidone, polyvinyl acetate, an ethylene polyvinyl acetate copolymer, polyvinyl acetate, an ethylene polyvinyl acetate copolymer, polyethylene oxide, cellulose acetate, cellulose acetate butyrate, cellulose acetate propionate cyanoethylpullulan, cyanoethyl polyvinyl alcohol, cyanoethyl cellulose, cyanoethyl sucrose, pullulan, carboxymethylcellulose, an acrylonitrile styrene butadiene copolymer, polyimide, and combinations thereof.

Each of the electrode assemblies according to the above-described embodiments may include an electrolyte disposed between the negative electrode and the positive electrode. In some embodiments, the electrolyte may include a nonaqueous electrolyte and a lithium salt. In some embodiments, the nonaqueous electrolyte may be a nonaqueous electrolyte solution, an organic solid electrolyte, or an inorganic solid electrolyte. The lithium salt, the nonaqueous electrolyte solution, the organic solid electrolyte, and the inorganic solid electrolyte may be those commonly used in lithium secondary batteries in the art.

According to another embodiment of the present disclosure, a secondary battery includes any of the electrode assemblies according to the above-described embodiments. The secondary battery may include one or at least two of the electrode assemblies according to the above-described embodiments.

In some embodiments, the secondary battery may be a cylindrical battery that may be manufactured by encasing any of the above-described electrode assemblies in a cylindrical case and injecting an electrolyte thereinto, or a rectangular battery that may be manufactured by pressing any of the above-described electrolyte assemblies into a planar shape, encasing the same in a rectangular case, and injecting an electrolyte thereinto. In some embodiments, the secondary battery may be a lithium secondary battery.

FIG. 5 is a schematic cross-sectional view of a secondary battery 102 according to an embodiment.

In some embodiments, the secondary battery 102 may include a case 10, and a plurality of electrode assemblies accommodated in the case 10. In some embodiments, at least three electrode assemblies may be accommodated in the case 10. In some embodiments, the plurality of electrode assemblies may be impregnated with an electrolyte (E).

Referring to FIG. 5, the secondary battery 102 may include the case 10, first and second electrode assemblies 20 and 30 encased in the case 10 and adjacent to inner walls of the case 10, and a third electrode assembly 40 encased in the case 10 between the first electrode assembly 20 and the second electrode assembly 30, wherein the third electrode assembly 40 may have a higher energy density than those of the first electrode assembly 20 and the second electrode assembly 30.

In some embodiments, the case 10 may include a metallic material to maintain a mechanical strength. In some embodiments, the case 10 may be in a rectangular or cylindrical form. In some embodiments, the case 10 may be in a pouch form manufactured by using a polymer.

In general, when a secondary battery includes only electrode assemblies having a high energy density, effective heat dissipation and current dispersion may not be achieved when an internal short caused by an internal or external impact occurs in the secondary battery, so that a fire or rupture of the secondary battery may more likely occur.

Unlike such a general secondary battery, a secondary battery according to an embodiment as described above may include first and second electrode assemblies disposed adjacent to the inner walls of a case to induce heat dissipation and current dispersion through the same when an internal short occurs. When such electrode assemblies with good thermal safety are disposed close to the inner walls of a case of a secondary battery, the consequential occurrence of a heat generation, a fire, and then a thermal runaway, caused by an internal short in the electrode assembly, may be effectively prevented, compared to when an electrode assembly with a high energy density is disposed close to an inner wall of the case of the secondary battery. In some embodiments, the first and second electrode assemblies may each include at least one lithium ion conductor layer as a protective layer. The first and second electrode assemblies may each further include a positive active material that has good structural and thermal safeties. In some embodiments, thicknesses of current collectors and/or separators of the first and second electrode assemblies may also be adjusted to improve the thermal safety of the secondary battery.

In some embodiments, the secondary battery may include a third electrode assembly that has a higher energy density than those of the first and second electrode assemblies and thus may mainly contribute to the total capacity of the secondary battery. In some embodiments, the first and second electrode assemblies may also contribute to the total capacity of the secondary battery since they are electrically connected to the third electrode assembly. Due to the above-described structure, the secondary battery may have both a high energy density and improved safety.

In some embodiments, the first electrode assembly may include a first positive electrode formed by coating a first positive active material on a first positive electrode current collector; a first negative electrode formed by coating a first negative active material on a first negative electrode current collector; and a first lithium ion conductor layer disposed at least in one of between the first positive electrode and the first negative electrode, on an outer surface of the first positive electrode, and on an outer surface of the first negative electrode. In some embodiments, the second electrode assembly may include a second positive electrode formed by coating a second positive active material on a second positive electrode current collector; a second negative electrode formed by coating a second negative active material on a second negative electrode current collector; and a second lithium ion conductor layer disposed at least in one of between the second positive electrode and the second negative electrode, on an outer surface of the second positive electrode, and on an outer surface of the second negative electrode. In some embodiments, the first lithium ion conductor layer of the first electrode assembly and the second lithium ion conductor layer of the second electrode assembly may be the same or different. In some embodiments, the third electrode assembly may include a third positive electrode formed by coating a third positive active material on a third positive electrode current collector; a third negative electrode formed by coating a third negative active material on a third negative electrode current collector; and a third separator disposed between the third positive electrode and the third negative electrode.

In some embodiments, the first electrode assembly may be formed by winding a stack of the first positive electrode, the first negative electrode, and the first lithium ion conductor layer that are stacked upon one another. In some embodiments, the second electrode assembly may be formed by winding a stack of the second positive electrode, the second negative electrode, and the second lithium ion conductor layer that are stacked upon one another. In some embodiments, the third electrode assembly may be formed by winding a stack of the third positive electrode, the third separator, and the third negative electrode that are sequentially stacked upon one another.

In some embodiments, the first and second electrode assemblies of the secondary battery may each be the same as any of the electrode assemblies described above with reference to FIGS. 2 to 4F. In some embodiments, the first and second lithium ion conductor layers of the first and second electrode assemblies may also be the same as any of the lithium ion conductor layers described above with reference to FIGS. 2 to 4F.

In some embodiments, the first and second electrode assemblies may each further include a separator between the positive electrode and the negative electrode. In some embodiments, the first electrode assembly may further include a first separator disposed between the first positive electrode and the first negative electrode, and the second electrode assembly may further include a second separator disposed between the second positive electrode and the second negative electrode.

When each of the first and second electrode assemblies further includes a separator between the positive electrode and the negative electrode, the first lithium ion conductor layer of the first electrode assembly may be disposed at least in one of between the first positive electrode and the first separator, between the first negative electrode and the first separator, on the outer surface of the first positive electrode, and on the outer surface of the first negative electrode. In some embodiments, the second lithium ion conductor layer of the second electrode assembly may be disposed at least in one of between the second positive electrode and the second separator, between the second negative electrode and the second separator, on the outer surface of the second positive electrode, and on the outer surface of the second negative electrode.

In some embodiments, the first, second, and third electrode assemblies may each further include another separator disposed on the outer surface of the positive electrode, or on the outer surface of the negative electrode to prevent an internal short.

In any of the secondary batteries according to the above-described embodiments, the first positive active material and the second positive active material may each independently include at least one of a lithium-nickel composite oxide represented by Formula 1, an olivine-based phosphoric acid compound represented by Formula 2, a spinel-based lithium-manganese composite oxide represented by Formula 3, and a combination thereof.

Liₐ(NiₓM′_{y})O₂ Formula 1

In Formula 1, M′ may be at least one element selected from the group consisting of cobalt (Co), manganese (Mn), iron (Fe), vanadium (V), copper (Cu), chromium (Cr), aluminum (Al), magnesium (Mg), and titanium (Ti), 0.9<a≦1.1, 0≦x<0.6, 0.4≦y≦1, and x+y=1, wherein M′ may be optionally substituted or doped with at least one heterogeneous element selected from calcium (Ca), magnesium (Mg), aluminum (Al), titanium (Ti), strontium (Sr), iron (Fe), cobalt (Co), nickel (Ni), copper (Cu), zinc (Zn), yttrium (Y), zirconium (Zr), niobium (Nb), and boron (B).

LiMPO₄ Formula 2

In Formula 2, M may be at least one element selected from the group consisting of Fe, Mn, Ni, Co, and V.

Li_{1+y}Mn_{2-y-z}M_{z}O₄₋ₓQₓ Formula 3

In Formula 3, M may be at least one element selected from the group consisting of Mg, Al, Ni, Co, Fe, Cr, Cu, boron (B), Ca, Nb, Mo, Sr, antimony (Sb), tungsten (W), Ti, V, Zr, and Zn, Q is at least one element selected from the group consisting of nitrogen (N), fluorine (F), sulfur (S), and Cl, 0≦x≦1, 0≦y≦0.34, and 0≦z≦1.

As described above, the first and second positive active materials may be appropriately determined to improve safety of the secondary battery.

In any of the secondary batteries according to the above-described embodiments, the third positive active material may include a lithium-nickel composite oxide represented by Formula 4:

Liₐ(NiₓM′_{y}M″_{z})O₂ Formula 4

In Formula 4, M′ may be at least one element selected from the group consisting of Co, Mn, Ni, Al, Mg, and Ti, M″ is at least one element selected from the group consisting of Ca, Mg, Al, Ti, Sr, Fe, Co, Ni, Cu, Zn, Y, Zr, Nb, boron (B), and a combination thereof, 0.4<a≦1.3, 0.6≦x≦1, 0≦y≦0.4, 0≦z≦0.4, and x+y+z=1.

In some embodiments, the third positive active material may include a lithium-nickel composite oxide having the composition of LiNi_{0.83}Co_{0.15}Al_{0.02}O₂. In some embodiments, an amount of Ni in the lithium-nickel composite oxide of the third positive active material may be greater than those of Ni in the lithium-nickel composite oxides of the first and second positive active materials.

When the third positive active material includes a lithium-nickel composite oxide containing a larger amount of Ni than in the lithium-nickel composite oxides of the first and second positive active materials, the third positive active material may have a layered structure having a high electrical conductivity, so that an electrode assembly of a secondary battery having a high capacity and a high energy density may be obtained.

Therefore, the compositions of the first, second, and third positive active materials may be appropriately varied to provide a secondary battery having a high energy density and ensured thermal safety.

In some embodiments, the first, second, and third negative active materials of the secondary battery may be the same as the negative active materials described above.

In some embodiments, the first, second, and third positive or negative current collectors of the secondary battery may be the same as the positive or negative current collectors described above. In some embodiments, a thickness of the first positive electrode current collector and a thickness of the second positive electrode current collector may be the same or different and may be each independently 1 to about 2 times greater than a thickness of the third positive current collector. In some embodiments, a thickness of the first negative electrode current collector and a thickness of the second negative electrode current collector may be the same or different and may be each independently 1 to about 2 times greater than a thickness of the third negative current collector. When the thicknesses of the first and second positive electrode current collector and the thicknesses of the first and second negative current collectors are greater than the thicknesses of the third positive electrode current collector and the third negative current collector, respectively, within these ranges, effective heat dissipation and current dispersion may be achieved. When the thicknesses of the third positive electrode current collector and the third negative electrode current collector are within the above ranges, the third electrode assembly may have a space for other elements that is larger than in the first and second electrode assemblies, so that the secondary battery may have an increased capacity per unit volume.

In any of the secondary batteries according to the above-described embodiments, the positive electrode and the negative electrode may be manufactured using the methods as described above.

In any of the secondary batteries according to the above-described embodiments, the first, second, and third separators may be the same as the separators described above. In some embodiments, a thickness of the first separator and a thickness of the second separator may be the same or different, and may be each independently 1 to about 2 times greater than a thickness of the third separator.

When the thicknesses of the first and second separators are greater than the thickness of the third separator within this range, melting of the first and second separators by heat may be prevented to block or delay a short circuit of the positive electrode and the negative electrode. When the thickness of the third separator is within the above range, the third electrode assembly may have a space for other elements that is larger than in the first and second electrode assemblies, so that the secondary battery may have an increased capacity per unit volume.

In some embodiments, the first and second separator may each be coated with an inorganic or organic material to prevent spreading of a short circuit area and to improve heat absorption characteristics thereof. The inorganic and organic materials may be the same as described above.

In some embodiments, any of the secondary batteries according to the above-described embodiments may further include an electrolyte between the negative electrode and the positive electrode in each of the first, second, and third electrolyte assemblies, and another electrolyte with which the plurality of electrolyte assemblies are impregnated. These electrolytes may be the same as described above.

In some embodiments, the plurality of electrode assemblies of any of the secondary batteries according to the above-described embodiments may be manufactured as described above, and may be electrically connected to each other as follows. A non-coated region of the third positive electrode of the third electrode assembly may be electrically connected to a non-coated region of the first positive electrode of the first electrode assembly and a non-coated region of the second positive electrode of the second electrode assembly. Likewise, a non-coated region of the third negative electrode of the third electrode assembly may be electrically connected to a non-coated region of the first negative electrode of the first electrode assembly and a non-coated region of the second negative electrode of the second electrode assembly.

In any of the secondary batteries according to the above-described embodiments, a positive electrode tab on the outermost side of each of the jelly-roll type electrode assemblies may be directly connected to a battery case, while a negative electrode tab extending from the non-coated region of the negative electrode may protrude to contact a pin, so that a structure of electrical connection to the outside may be achieved.

Although the embodiments of including three electrode assemblies in a battery case are described above, embodiments of the present disclosure are not limited thereto.

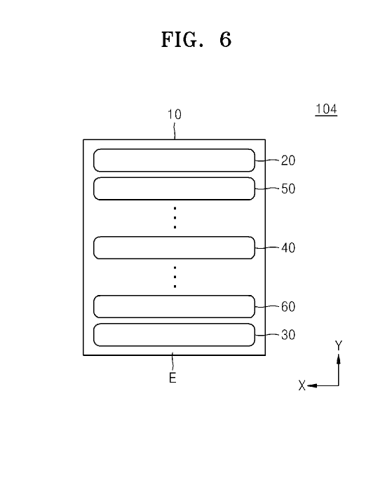

FIG. 6 is a schematic cross-sectional view of a secondary battery 104 according to another embodiment.

Referring to FIG. 6, the secondary battery 104 may include a case 10, first and second electrode assemblies 20 and 30 disposed close to inner walls of the case 10, and a plurality of electrode assemblies disposed between the first electrode assembly 20 and the second electrode assembly 30. For example, the plurality of electrode assemblies disposed between the first electrode assembly 20 and the second electrode assembly 30 may include a third electrode assembly 40, a fourth electrode assembly 50, and a fifth electrode assembly 60 that have high energy densities. In some embodiments, the third electrode assembly 40, the fourth electrode assembly 50, and the fifth electrode assembly 60 disposed between the first electrode assembly 20 and the second electrode assembly 30 may have the same structure as the third electrode assembly 40 described above with reference to FIG. 5.

In some embodiments, the secondary battery 104 may be a lithium secondary battery.

Any of the secondary batteries according to the above-described embodiments may be used as a battery cell available as a power source of a small device, or as a unit cell of a multi-cell battery module for a medium- or large-sized device.

Non-limiting examples of the medium- or large-sized device are power tools; electric cars (referred to as xEV), including electric vehicles (EVs), hybrid electric vehicles (HEVs), and plug-in hybrid electric vehicles (PHEVs); and electric two-wheeled vehicles, including E-bikes and E-scooters; electric golf carts; electric trucks; electric commercial vehicles; and power storage systems.

One or more embodiments of the present disclosure will now be described in detail with reference to the following examples. However, these examples are only for illustrative purposes and are not intended to limit the scope of the one or more embodiments of the present disclosure.

### Example 1

### Manufacture of Secondary Battery Including One Electrode Assembly

### 1) Manufacture of Positive Electrode

94 wt % of LiNi_{1/3}Co_{1/3}Mn_{1/3}O₂ as a positive active material, 3 wt % of Super P carbon black as a conducting agent, and 3 wt % of polyvinylidene fluoride (PVdF) as a binder were mixed in N-methylpyrrolidone (NMP) as a solvent to prepare a positive electrode slurry composition. The positive electrode slurry composition was coated on an aluminum current collector having a thickness of 15 μm by using a common method, dried and then pressed to manufacture a positive electrode.

### 2) Manufacture of Negative Electrode

96 wt % of natural graphite as a negative active material, and 4 wt % of PVdF as a binder were mixed in N-methylpyrrolidone as a solvent to prepare a negative electrode slurry composition. The negative electrode slurry composition was coated on a copper current collector having a thickness of 14 μm by using a common method, dried and then pressed to manufacture a negative electrode.

### 3) Manufacture of Electrode Assembly

Separators comprising of polyethylene (PE) films and a Li₂O—Al₂O₃—SiO₂—P₂O₅—TiO₂—GeO₂ membrane (a lithium superionic conductor (LISICON), available from Ohara, Sagamihara-Shi, Japan) as a lithium ion conductor layer were prepared. Next, the positive electrode manufactured above, the lithium ion conductor layer, the separator, the negative electrode manufactured above, and another separator were sequentially stacked upon one another, and then wound to manufacture a jelly-roll type electrode assembly.

### 4) Manufacture of Secondary Battery

The electrode assembly manufactured as above was encased in a rectangular case, and then an electrolyte of 1.3 M LiPF₆ lithium salt in a mixed solvent of ethylene carbonate (EC), ethyl methyl carbonate (EMC), and dimethyl carbonate (DMC) in a ratio of 1:1:1 by volume was injected into the rectangular case, thereby manufacturing a lithium secondary battery. The lithium secondary battery had an energy density of about 2500 mAh.

### Example 2

### Manufacture of Secondary Battery Including One Electrode Assembly

A secondary battery was manufactured in substantially the same manner as in Example 1, except that the positive electrode manufactured as above, the separator, the lithium ion conductor layer, the negative electrode manufactured as above, and another separator were sequentially stacked upon one another, and then wound to manufacture a jelly-roll type electrode assembly.

### Example 3

### Manufacture of Secondary Battery Including One Electrode Assembly

A secondary battery was manufactured in substantially the same manner as in Example 1, except that the positive electrode manufactured as above, the lithium ion conductor layer, the separator, another lithium ion conductor layer, the negative electrode manufactured as above, and another separator were sequentially stacked upon one another, and then wound to manufacture a jelly-roll type electrode assembly.

### Example 4

### Manufacture of Secondary Battery Including One Assembly

A secondary battery was manufactured in substantially the same manner as in Example 1, except that the positive electrode manufactured as above, the lithium ion conductor layer, the separator, another lithium ion conductor layer, the negative electrode manufactured as above, another lithium ion conductor layer, and another separator were sequentially stacked upon one another, and then wound to manufacture a jelly-roll type electrode assembly.

### Comparative Example 1

### Manufacture of Secondary Battery Including One Electrode Assembly

A secondary battery was manufactured in substantially the same manner as in Example 1, except that the positive electrode manufactured as above, the separator, the negative electrode manufactured as above, and another separator were sequentially stacked upon one another without a lithium ion conductor layer, and then wound to manufacture a jelly-roll type electrode assembly.

### Comparative Example 2

### Manufacture of Secondary Battery Including One Electrode Assembly

A secondary battery was manufactured in substantially the same manner as in Comparative Example 1, except that 94 wt % of LiNi_{0.83}CO_{0.15}Al_{0.02}O₂ was used as the positive active material. The lithium secondary battery had an energy density of about 2800 mAh.

### Example 5

### Manufacture of Secondary Battery Including Three Electrode Assemblies

Two electrode assemblies manufactured in Example 1 were placed in a rectangular case adjacent to inner walls of the rectangular case, with the electrode assembly of Comparative Example 2 placed between the two electrode assemblies of Example 1, and then an electrolyte of 1.3 M LiPF₆ lithium salt in a mixed solvent of ethylene carbonate (EC), ethyl methyl carbonate (EMC), and dimethyl carbonate (DMC) in a ratio of 1:1:1 by volume was injected into the rectangular case, thereby manufacturing a rectangular lithium secondary battery.

### Example 6

### Manufacture of Secondary Battery Including Three Electrode Assemblies

Two electrode assemblies manufactured in Example 2 were placed in a rectangular case adjacent to inner walls of the rectangular case, with the electrode assembly of Comparative Example 2 placed between the two electrode assemblies of Example 2, and then an electrolyte of 1.3M LiPF₆ lithium salt in a mixed solvent of EC, EMC, and DMC in a ratio of 1:1:1 by volume was injected into the rectangular case, thereby manufacturing a rectangular lithium secondary battery.

### Example 7

### Manufacture of Secondary Battery Including Three Electrode Assemblies

Two electrode assemblies manufactured in Example 3 were placed in a rectangular case adjacent to inner walls of the rectangular case, with the electrode assembly of Comparative Example 2 placed between the two electrode assemblies of Example 3, and then an electrolyte of 1.3 M LiPF₆ lithium salt in a mixed solvent of EC, EMC, and DMC in a ratio of 1:1:1 by volume was injected into the rectangular case, thereby manufacturing a rectangular lithium secondary battery.

### Example 8

### Manufacture of Secondary Battery Including Three Electrode Assemblies

Two electrode assemblies manufactured in Example 4 were placed in a rectangular case adjacent to inner walls of the rectangular case, with the electrode assembly of Comparative Example 2 placed between the two electrode assemblies of Example 4, and then an electrolyte of 1.3M LiPF₆ lithium salt in a mixed solvent of EC, EMC, and DMC in a ratio of 1:1:1 by volume was injected into the rectangular case, thereby manufacturing a rectangular lithium secondary battery.

### Comparative Example 3

### Manufacture of Secondary Battery Including Three Electrode Assemblies

Three electrode assemblies manufactured in Comparative Example 1 were encased in a rectangular case, and then an electrolyte of a 1.3 M LiPF₆ lithium salt in a mixed solvent of EC, EMC, and DMC in a ratio of 1:1:1 by volume was injected into the rectangular case, thereby manufacturing a rectangular lithium secondary battery.

### Comparative Example 4

### Manufacture of Secondary Battery Including Three Electrode Assemblies

Three electrode assemblies manufactured in Comparative Example 2 were encased in a rectangular case, and then an electrolyte of a 1.3 M LiPF₆ lithium salt in a mixed solvent of EC, EMC, and DMC in a ratio of 1:1:1 by volume was injected into the rectangular case, thereby manufacturing a rectangular lithium secondary battery.

### Evaluation Example

### Penetration Test and Compression Test

Penetration and compression tests were performed on the lithium secondary batteries of Examples 1 to 8 and Comparative Examples 1 to 4 as follows. The results are shown in Table 1 below.

The penetration test is a simulation of an internal short in a lithium secondary battery caused by an internal or external impact. After the lithium secondary batteries were subjected to charging in a standard condition (at 0.5 C to 4.2 V, and 0.05 C (cut-off)) and then resting for about 10 minutes or longer (up to 72 hours), each of the lithium secondary batteries was completely penetrated through the middle thereof with a nail (a 3 mm diameter) at a rate of about 60 mm/sec, and maintained until a surface temperature of the lithium secondary battery reached about 40° C. or less.

The compression test as a safety measure of a battery against compression by a waste crusher is a simulation of an internal short in the battery caused by an external pressure. After the lithium secondary batteries were subjected to charging in a standard condition (at 0.5 C to 4.2 V, and 0.05 C (cut-off)) and then resting for about 10 minutes or longer (up to 72 hours), each of the lithium secondary batteries was compressed with a force of about 13 kN in a direction parallel to the lengthwise direction of the lithium secondary battery and then released from the force in one second. Each of the lithium secondary batteries maintained until a surface temperature thereof reached about 40° C. or less.

TABLE 1

| | Penetration | Compression |
|---|---|---|
| Example | Test Result | Test Result |
| Example 1 | Pass | Pass |
| Example 2 | Pass | Pass |
| Example 3 | Pass | Pass |
| Example 4 | Pass | Pass |
| Example 5 | Pass | Pass |
| Example 6 | Pass | Pass |
| Example 7 | Pass | Pass |
| Example 8 | Pass | Pass |
| Comparative | Fail | Fail |
| Example 1 | | |
| Comparative | Fail | Fail |
| Example 2 | | |
| Comparative | Fail | Fail |
| Example 3 | | |
| Comparative | Fail | Fail |
| Example 4 | | |

Referring to Table 1, the secondary batteries of Examples 1 to 8 including electrode assemblies including lithium ion conductor layers were found to induce effective heat dissipation and current dispersion when an internal short occurred. Meanwhile, the secondary batteries of Comparative Examples 1 and 2 including an electrode assembly without a lithium ion conductor layer were found to have high energy densities, but poor thermal safety, and thus fail both the penetration test and the compression test.

In particular, for the secondary batteries of Examples 5 to 8 including three electrode assemblies, both thermal safety and high energy density were ensured by disposing electrode assemblies with high thermal safety close to the case and an electrode assembly having a high energy density between the electrode assemblies with high thermal safety.

As described above, according to the one or more of the above embodiments of the present disclosure, an electrode assembly may include lithium ion conductor layer serving as an electrolyte and separator at least in one of between a positive electrode and a negative electrode, on an outer surface of the positive electrode, and on an outer surface of the negative electrode to prevent an internal short and improve safety. A secondary battery may include electrode assembly having high energy density between the electrode assemblies disposed close to inner walls of a case, each of the electrode assemblies disposed close to the case including lithium ion conductor layer serving as an electrolyte and separator at least in one of between a positive electrode and a negative electrode, on an outer surface of the positive electrode, and on an outer surface of the negative electrode to prevent an internal short and improve safety. As a result, the secondary battery may have a high energy density and may induce effective heat dissipation and current dispersion when an internal short occurs in the battery.

In the present disclosure, the terms “Example,” “Comparative Example” and “Evaluation Example” are used arbitrarily to simply identify a particular example or experimentation and should not be interpreted as admission of prior art. While one or more embodiments of the present disclosure have been described with reference to the figures, it will be understood by those of ordinary skill in the art that various changes in form and details may be made therein without departing from the spirit and scope of the present disclosure as defined by the following claims.

What is claimed is:

1. An electrode assembly, comprising:
a positive electrode comprising a positive electrode current collector and a positive active material coated on the positive electrode current collector;
a negative electrode comprising a negative electrode current collector and a negative active material coated on the negative electrode current collector; and
a lithium ion conductor layer disposed at least in one of a) between the positive electrode and the negative electrode, b) on an outer surface of the positive electrode, and c) on an outer surface of the negative electrode.

2. The electrode assembly of claim 1, wherein the electrode assembly has a wound stack of the positive electrode, the negative electrode, and the lithium ion conductor layer.

3. The electrode assembly of claim 1, wherein the lithium ion conductor layer is disposed at least in two of a), b), and c).

4. The electrode assembly of claim 1, further comprising a separator disposed between the positive electrode and the negative electrode.

5. The electrode assembly of claim 4, wherein the lithium ion conductor layer is disposed at least in one of between the positive electrode and the separator, between the negative electrode and the separator, on the outer surface of the positive electrode, and on the outer surface of the negative electrode.

6. The electrode assembly of claim 1, wherein the lithium ion conductor layer comprises at least one sulfide-based lithium ion conductor selected from the group consisting of a lithium superionic conductor (LISICON), a Garnet lithium ion conductor, a Perovskite lithium ion conductor, a lithium phosphorus oxinitride (LIPON) lithium ion conductor, an sodium (Na) superionic conductor (NASICON), and a combination thereof.

7. The electrode assembly of claim 1, wherein the positive active material comprises at least one of a lithium-nickel composite oxide represented by Formula 1, an olivine-based phosphoric acid compound represented by Formula 2, a spinel-based lithium-manganese composite oxide represented by Formula 3, and a combination thereof:
Liₐ(NiₓM′_{y})O₂ Formula 1
wherein, in Formula 1, M′ is at least one element selected from the group consisting of cobalt (Co), manganese (Mn), iron (Fe), vanadium (V), copper (Cu), chromium (Cr), aluminum (Al), magnesium (Mg), and titanium (Ti), 0.9<a≦1.1, 0≦x<0.6, 0.4≦y≦1, and x+y=1, wherein M′ is optionally substituted or doped with at least one heterogeneous element selected from the group consisting of calcium (Ca), magnesium (Mg), aluminum (Al), titanium (Ti), strontium (Sr), iron (Fe), cobalt (Co), nickel (Ni), copper (Cu), zinc (Zn), yttrium (Y), zirconium (Zr), niobium (Nb), and boron (B);
LiMPO₄ Formula 2
wherein, in Formula 2, M is at least one element selected from the group consisting of Fe, Mn, Ni, Co, and V; and
Li_{1+y}Mn_{2-y-z}M_{z}O₄₋ₓQₓ Formula 3
wherein, in Formula 3, M is at least one element selected from the group consisting of Mg, Al, Ni, Co, Fe, Cr, Cu, B, Ca, Nb, Mo, Sr, antimony (Sb), tungsten (W), boron (B), Ti, V, Zr, and Zn, and Q is at least one element selected from the group consisting of nitrogen (N), fluorine (F), sulfur (S), and chlorine (Cl), 0≦x≦1, 0≦y≦0.34, and 0≦z≦1.

8. The electrode assembly of claim 1, wherein the lithium ion conductor layer has a thickness of about 5 nm to about 500 μm

9. The electrode assembly of claim 4, wherein the separator is coated with an inorganic material or an organic material.

10. A secondary battery comprising the electrode assembly of claim 1.

11. A secondary battery, comprising:
a case;
a first electrode assembly and a second electrode assembly adjacent to inner walls of the case; and
a third electrode assembly disposed between the first electrode assembly and the second electrode assembly in the case,
wherein an energy density of the third electrode assembly is higher than energy densities of the first electrode assembly and the second electrode assembly.

12. The secondary battery of claim 11, wherein the first electrode assembly comprises a first positive electrode comprising a first positive electrode current collector and a first positive active material coated on the first positive electrode current collector; a first negative electrode comprising a first negative electrode current collector and a first negative active material coated on the first negative electrode current collector; and a first lithium ion conductor layer disposed at least in one of between the first positive electrode and the first negative electrode, on an outer surface of the first positive electrode, and an outer surface of the first negative electrode, and wherein the second electrode assembly comprises a second positive electrode comprising a second positive electrode current collector and a second positive active material coated on the second positive electrode current collector; a second negative electrode comprising a second negative electrode current collector and a second negative active material coated on the second negative electrode current collector; and a second lithium ion conductor layer disposed at least in one of between the second positive electrode and the second negative electrode, on an outer surface of the second positive electrode, and an outer surface of the second negative electrode, and wherein the third electrode assembly comprises a third positive electrode comprising a third positive electrode current collector and a third positive active material coated on the positive electrode current collector; a third negative electrode comprising a third negative electrode current collector and a third negative active material coated on the third negative electrode current collector; and a third separator disposed between the third positive electrode and the third negative electrode.

13. The secondary battery of claim 12, wherein the first electrode assembly has a wound stack of the first positive electrode, the first negative electrode, and the first lithium ion conductor layer; wherein the second electrode assembly has a wound stack of the second positive electrode, the second negative electrode, and the second lithium ion conductor layer; and wherein the third electrode assembly has a wound stack of the third positive electrode, the third separator, and the third negative electrode.

14. The secondary battery of claim 12, wherein the first electrode assembly further comprises a first separator disposed between the first positive electrode and the first negative electrode, and the second electrode assembly further comprises a second separator disposed between the second positive electrode and the second negative electrode.

15. The secondary battery of claim 14, wherein the first lithium ion conductor layer is disposed at least in one of between the first positive electrode and the first separator, between the first negative electrode and the first separator, on the outer surface of the first positive electrode, and on the outer surface of the first negative electrode, and wherein the second lithium ion conductor layer is disposed at least in one of between the second positive electrode and the second separator, between the second negative electrode and the second separator, on the outer surface of the second positive electrode, and on the outer surface of the second negative electrode.

16. The secondary battery of claim 12, wherein the first lithium ion conductor layer and the second lithium ion conductor layer each comprises at least one sulfide-based lithium ion conductor selected from the group consisting of a lithium superionic conductor (LISICON), a Garnet lithium ion conductor, a Perovskite lithium ion conductor, a lithium phosphorus oxinitride (LIPON) lithium ion conductor, an Na superionic conductor (NASICON), and a combination thereof, and wherein the first lithium ion conductor layer and the second lithium ion conductor layer each have a thickness of about 5 nm to about 500 μm

17. The secondary battery of claim 12, wherein the first positive active material and the second positive active material each independently comprise at least one of a lithium-nickel composite oxide represented by Formula 1, an olivine-based phosphoric acid compound represented by Formula 2, a spinel-based lithium manganese composite oxide represented by Formula 3, and a combination thereof:
Liₐ(NiₓM′_{y})O₂ Formula 1
wherein, in Formula 1, M′ is at least one element selected from the group consisting of cobalt (Co), manganese (Mn), iron (Fe), vanadium (V), copper (Cu), chromium (Cr), aluminum (Al), magnesium (Mg), and titanium (Ti), 0.9<a≦1.1, 0≦x<0.6, 0.4≦y≦1, and x+y=1, wherein M′ is optionally substituted or doped with at least one heterogeneous element selected from calcium (Ca), magnesium (Mg), aluminum (Al), titanium (Ti), strontium (Sr), iron (Fe), cobalt (Co), nickel (Ni), copper (Cu), zinc (Zn), yttrium (Y), zirconium (Zr), niobium (Nb), and boron (B);
LiMPO₄ Formula 2
wherein, in Formula 2, M is at least one element selected from the group consisting of Fe, Mn, Ni, Co, and V; and
Li_{1+y}Mn_{2-y-z}M_{z}O₄₋ₓQₓ Formula 3
wherein, in Formula 3, M is at least one element selected from the group consisting of Mg, Al, Ni, Co, Fe, Cr, Cu, boron (B), Ca, Nb, Mo, Sr, antimony (Sb), tungsten (W), Ti, V, Zr, and Zn, and Q is at least one element selected from the group consisting of nitrogen (N), fluorine (F), sulfur (S), and Cl, 0≦x≦1, 0≦y≦0.34, and 0≦z≦1.

18. The secondary battery of claim 12, wherein the third positive active material comprises a lithium-nickel composite oxide represented by Formula 4:
Liₐ(NiₓM′_{y}M″_{z})O₂ Formula 4
wherein, in Formula 4, M′ is at least one element selected from the group consisting of Co, Mn, Ni, Al, Mg, and Ti, M″ is at least one element selected from the group consisting of Ca, Mg, Al, Ti, Sr, Fe, Co, Ni, Cu, Zn, Y, Zr, Nb, boron (B), and combinations thereof, 0.4<a≦1.3, 0.6≦x≦1, 0≦y≦0.4, 0≦z≦0.4, and x+y+z=1.

19. The secondary battery of claim 12, wherein a thickness of the first positive electrode current collector and a thickness of the second positive electrode current collector are each independently 1 to about 2 times greater than a thickness of the third positive electrode current collector, and wherein a thickness of the first negative electrode current collector and a thickness of the second negative electrode current collector are each independently 1 to about 2 times greater than a thickness of the third negative electrode current collector.

20. The secondary battery of claim 14, wherein a thickness of the first separator and a thickness of the second separator are the same or different, and are 1 to about 2 times greater than a thickness of the third separator, and wherein the first separator or the second separator is coated with an inorganic material or an organic material.
